(19) United States
(12) Patent Application Publication
(10) Pub. No.: US 2005/0138566 A1
(43) Pub. Date: Jun. 23, 2005

(54) User interface, method, system and program product for managing collaboration data

(75) Inventors: Michael Muller, Medford, MA (US); Werner Geyer, Boston, MA (US); Li-Te Cheng, Malden, MA (US); Elizabeth A. Brownholtz, Andover, MA (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/738,900

(22) Filed: Dec. 17, 2003

(51) Int. Cl. G06F 3/00; G06F 15/16; H04N 5/44; H04M 11/00

(52) U.S. Cl. 715/759; 715/751; 715/752; 715/753; 715/758; 715/778; 715/781; 715/782; 715/783; 715/792; 715/804; 715/741; 715/743; 715/745; 715/747; 709/204; 715/716; 715/719; 455/416; 379/93.21; 379/93.23; 379/93.24

(57) ABSTRACT

A user interface, method, system and program product for managing collaboration data, in which a shared object is displayed in a user interface. Access to one or more collaboration management functions is provided in a portion of the user interface, and collaboration data for the shared object can be displayed in a portion of the user interface. As a result, the user is provided with a user interface that allows for both viewing and/or modifying a shared object and its corresponding collaboration data.

### BACKGROUND OF THE INVENTION

1. Technical Field

The invention relates generally to managing collaboration data, and more specifically to a user interface, method, system and program product for managing collaboration data for a shared object displayed in a user interface using a portion of the user interface.

2. Background Art

Typically, real-time collaboration, e.g., simultaneous editing of a shared object, by various users is performed in a specialized environment. In particular, users may be required to travel to a particular location, use a particular computing system, and/or use a specialized application in order to collaborate in real-time with other users. For example, a collaboration location could include specialized hardware and/or software that enables the real-time collaboration. In this case, shared objects would typically be stored in a unique location, and each user at the location could view every other user present to determine who is currently collaborating on the shared object.

A significant drawback of current collaboration solutions is the necessity for users to leave their personal workspace and/or use computing environments with which the user is less familiar. Further, a user that seeks to collaborate may be located at a remote location, and be unable to relocate to the collaboration location. As a result, it is increasingly desirable that users be able to collaborate using familiar software and/or without leaving their personal workspaces.

However, without users being located in an environment customized for collaboration, new problems arise with real-time and/or asynchronous collaboration. For example, a user is no longer capable of viewing all users that are currently collaborating on the shared object. Further, the user may not be able to readily discern the relationship between various shared objects since they can be stored in a central location along with other objects that are not being shared. When users in different locations collaborate on a shared object asynchronously, it is difficult to determine who has most recently modified the shared object, who has most recently viewed the shared object, and/or when these types of events occurred.

For both synchronous and asynchronous sharing, users are presented with additional difficulties in understanding the relationships among shared objects. While some shared objects may be self-explanatory, other shared objects may only make sense when a user can view its dependency on other shared objects. For example, a shared object could comprise a message sent in response to earlier messages, comments on a particular shared object (e.g., a document), graphical illustrations that support comments made in a chat or instant message session, or the like.

As a result, a need exists for a solution that allows a user to manage collaboration data while remaining at his/her personal workspace. Further, a need exists for a user to have readily available access to collaboration data and/or functions for modifying the collaboration data when viewing a shared object. Still further, a need exists for a user to be able to view the relationships among interrelated shared objects. In particular, a need exists for a user interface, method, system and program product for managing collaboration data for a shared object using a portion of a user interface that displays the shared object.

### SUMMARY OF THE INVENTION

The invention provides a solution for managing collaboration data for one or more shared objects using a portion of a user interface used to display a shared object and/or a set of shared objects to which a shared object may belong. In particular, the user interface can provide access to one or more collaboration functions used to manage the collaboration data. For example, the user interface may enable a user to view and/or manage all users that have permission to collaborate on the shared object, all users currently collaborating on the shared object, one or more related shared objects, etc. A user may also be allowed to manage collaboration data about one or more shared object events, e.g., user and/or date/time information for a shared object's creation, modification, and/or display, as well as other collaboration aspects of shared objects. As a result, a user can readily collaborate on the shared object and view and/or modify collaboration data for the shared object without connecting to a specialized collaboration environment.

A first aspect of the invention provides a method of managing collaboration data, the method comprising: generating a user interface for a shared object using an application; displaying the shared object in a first portion of the user interface; and managing collaboration data for the shared object in a second portion of the user interface.

A second aspect of the invention provides a user interface for managing collaboration data, the user interface comprising: a first portion of a user interface generated by an application for displaying a shared object; and a second portion of the user interface for managing collaboration data for the shared object.

A third aspect of the invention provides a system for managing collaboration data, the system comprising: an application for providing a user interface and displaying a shared object in a first portion of the user interface; and a sharing management system for managing collaboration data in a second portion of the user interface.

A fourth aspect of the invention provides a program product stored on a recordable medium for managing collaboration data, which when executed comprises: program code for providing a user interface for an application; program code for displaying a shared object in a first portion of the user interface; and program code for managing collaboration data for the shared object in a second portion of the user interface.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for managing collaboration data;

FIG. 2 shows an illustrative user interface that allows a user to view a shared object and manage its collaboration data;

FIG. 3 shows the user interface of FIG. 2 after a user has selected to manage user permissions;

FIG. 4 shows the user interface of FIG. 2 after a user has selected to manage an awareness of other users;

FIG. 5 shows an alternative user interface that allows a user to manage collaboration data that comprises both object-specific and user-specific data; and

FIG. 6 shows an illustrative user interface when collaboration data management is implemented as part of an application.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for managing collaboration data for one or more shared objects using a portion of a user interface used to display a shared object and/or a set of shared objects to which a shared object may belong. In particular, the user interface can provide access to one or more collaboration functions used to manage the collaboration data. For example, the user interface may enable a user to view and/or manage all users that have permission to collaborate on the shared object, all users currently collaborating on the shared object, one or more related shared objects, etc. A user may also be allowed to manage collaboration data about one or more shared object events, e.g., user and/or date/time information for a shared object's creation, modification, and/or display, as well as other collaboration aspects of shared objects. As a result, a user can readily collaborate on the shared object and view and/or modify collaboration data for the shared object without connecting to a specialized collaboration environment.

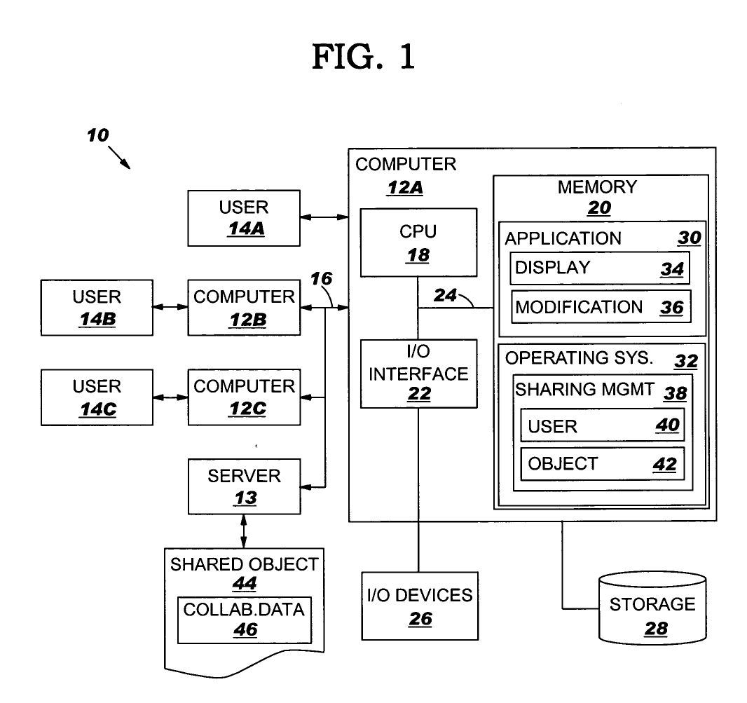

Turning to the drawings, FIG. 1 shows an illustrative system 10 for managing collaboration data 46. In particular, one or more users 14A-C can display a shared object 44 (e.g., a document, image, etc.) in a user interface provided by an application 30. Shared object 44 can include collaboration data 46 that can be managed by one or more users 14A-C using a portion of the user interface. As shown, shared object 44 can be stored at a server 13, and each user 14A-C can access shared object 44 using a computer 12A-C in communication with server 13 over a network 16. To this extent, network 16 can comprise any type of communications link. For example, network 16 can comprise an addressable connection in a client-server (or server-server) environment that may utilize any combination of wireline and/or wireless transmission methods. In this instance, computers 12A-C and server 13 may utilize conventional network connectivity, such as Token Ring, Ethernet, WiFi or other conventional communications standards. Further, network 16 can comprise any type of network, including the Internet, a wide area network (WAN), a local area network (LAN), a virtual private network (VPN), etc. Where computers 12A-C and server 13 communicate via the Internet, connectivity could be provided by conventional TCP/IP sockets-based protocol, and one or more computers 12A-C and/or server 13 could utilize an Internet service provider to establish connectivity.

As shown, computer 12A generally includes a central processing unit (CPU) 18, a memory 20, an input/output (I/O) interface 22, a bus 24, external I/O devices/resources 26, and a storage unit 28. CPU 18 may comprise a single processing unit, or be distributed across one or more processing units in one or more locations, e.g., on a client and server. Memory 20 may comprise any known type of data storage and/or transmission media, including magnetic media, optical media, random access memory (RAM), read-only memory (ROM), a data cache, a data object, etc. Storage unit 28 may comprise any type of data storage for providing storage for information necessary to carry out the invention as described below. As such, storage unit 28 may include one or more storage devices, such as a magnetic disk drive or an optical disk drive. Moreover, similar to CPU 18, memory 20 and/or storage unit 28 may reside at a single physical location, comprising one or more types of data storage, or be distributed across a plurality of physical systems in various forms. Further, memory 20 and/or storage unit 28 can include data distributed across, for example, a LAN, a WAN or a storage area network (SAN) (not shown).

I/O interface 22 may comprise any system for exchanging information to/from one or more external I/O devices 26. I/O devices 26 may comprise any known type of external device, including speakers, a CRT, LED screen, handheld device, keyboard, mouse, voice recognition system, speech output system, printer, monitor/display, facsimile, pager, communication hardware/software, etc. Bus 24 provides a communication link between each of the components in computer 12A and likewise may comprise any known type of transmission link, including electrical, optical, wireless, etc. In addition, computer 12A is shown including an operating system 32 that provides an interface between application 30, and the various hardware components included in computer 12A. It is understood that computer 12A is only an illustrative representation of a computing device. As a result, various combinations of components may be incorporated into computer 12A.

It is also understood that computers 12B-C and server 13 typically include the same elements as shown in computer 12A (e.g., CPU, memory, I/O interface, etc.). These have not been separately shown and discussed for brevity. Further, it is understood that each computer 12A-C and server 13 comprises any type of computing device capable of communicating with one or more other computing devices, such as a server, a desktop computer, a laptop, a handheld device, a mobile phone, a pager, a personal data assistant, etc. However, it is understood that if a computer 12A-C is a handheld device or the like, a display could be contained within the computer 12A-C, and not as an external I/O device 26 as shown for computer 12A.

Computer 12A is shown including an application 30 for providing a user interface for shared object 44. To this extent, application 30 can include a display system 34 for managing the contents of the user interface. Further, application 30 can include a modification system 36 that enables a user 14A-C to modify shared object 44. As is known in the art, when initially started, application 30 can request that operating system 32 create the user interface. Once created, display system 34 and/or modification system 36 can manage the content for most of the user interface, while operating system 40 can manage the content for a portion of the user interface. It is understood that application 30 can comprise any type of application. For example, application 30 could comprise a “high level” software product such as word processing software (e.g., International Business Machine's (IBM) Lotus Word Pro), spreadsheet software (e.g., IBM's Lotus 1-2-3), drawing software (e.g., IBM's Lotus Freelance Graphics), or the like. Further, application 30 could comprise “low level” software (e.g., utility software) that is provided as part of operating system 32, e.g., Microsoft's Windows Explorer, a shell program in Unix or Linux, or the like.

As shown, system 10 comprises a “client-server” type network 16, e.g., each user 14A-C accesses shared object 44 that is stored on server 13 using an application 30 that is stored on his/her corresponding computer 12A-C. However, it is understood that network 16 can comprise any type of network. For example, shared object 44 could be stored on computer 12A, e.g., in storage unit 28, and users 14B-C could access shared object 44 in a “peer-to-peer” fashion, without the use of server 13. Additional shared objects 44 could be stored on computers 12B-C, and be accessed in a similar manner by users 14A-C. Further, application 30 could be located on server 13, on which each user 14A-C would access it. Still further, while collaboration data 46 is shown stored as part of shared object 44, it is understood that some or all of collaboration data 46 could be stored separately from shared object 44, e.g., in a database or the like.

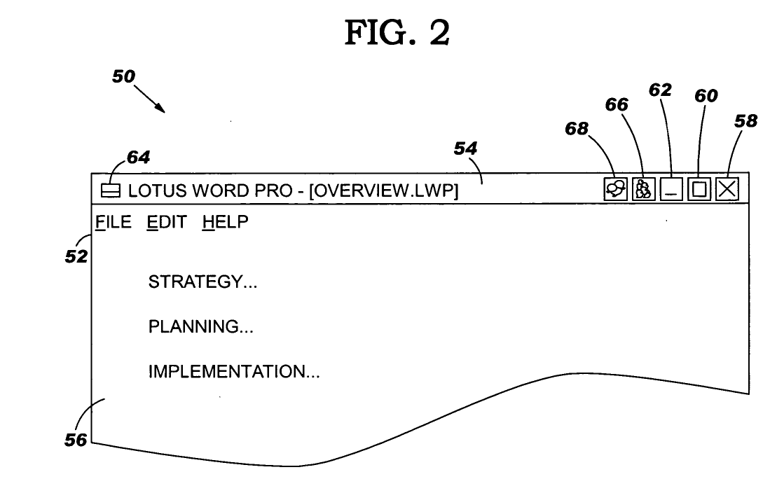

FIG. 2 shows a portion of an illustrative user interface 50 that comprises a window 52, such as one generated by Microsoft's Windows® operating system 32 (FIG. 1). A portion of window 52 can comprise a title bar 54 that displays information about window 52 (e.g., name of application and name of object being displayed), while another portion of window 52, typically comprising most of user interface 50, can comprise a workspace 56 that can display content based on a shared object 44 (FIG. 1). To this extent, the content of title bar 54 can be managed by operating system 32, while the content of workspace 56 can be managed by application 30.

Title bar 54 can provide access to various functions implemented by operating system 32. For example, title bar 54 is shown including a close icon 58, a maximize/restore icon 60, and a minimize icon 62 as are known in the art. Further, title bar 54 is shown including a system menu icon 64 that can provide access to the various functions performed by operating system 32 via a drop down menu or the like.

Returning to FIG. 1, operating system 32 is shown including a sharing management system 38 that allows user 14A to manage collaboration data 46 for shared object 44. Collaboration data 46 can comprise any data that is used to manage collaboration by users 14A-C on shared object 44. For example, collaboration data 46 can include authorship data, readership data, related objects (shared or not shared), user data, etc. To this extent, collaboration data 46 typically includes data about the set (one or more) of users 14A-C allowed to collaborate on shared object 44. As a result, sharing management system 38 can include a user system 40 for managing user-specific collaboration data 46 (e.g., the set of users 14A-C). Further, collaboration data 46 can comprise data about shared object 44 and/or one or more related shared objects 44. To this extent, sharing management system 38 can also include an object system 42 for managing object-specific collaboration data 46.

As previously noted, sharing management system 38 manages collaboration data 46 for shared object 44. To this extent, sharing management system 38 can provide access to one or more functions for managing collaboration data 46 to users 14A-C. For example, a user interface for any type of application 30 (FIG. 1), such as IBM's Lotus Word Pro, can have access to one or more collaboration management functions integrated therein. Returning to FIG. 2, title bar 54 is shown including a permissions icon 66 and an awareness icon 68. As shown, Permissions icon 66 and awareness icon 68 can each provide users 14A-C (FIG. 1) with access to one or more collaboration management functions. The collaboration management functions can manage user-specific collaboration data using user system 40 (FIG. 1).

To this extent, user-specific collaboration data 46 (FIG. 1) can identify a set of collaboration users for shared object 44. The set of collaboration users can comprise those users 14A-C (FIG. 1) that currently have permission to access shared object 44 (FIG. 1). The set of collaboration users can include users 14A-C that have varying permissions to access shared object 44. For example, the set of collaboration users could include a set of users that are allowed to modify shared object 44, and another set of users that are only allowed to view shared object 44.

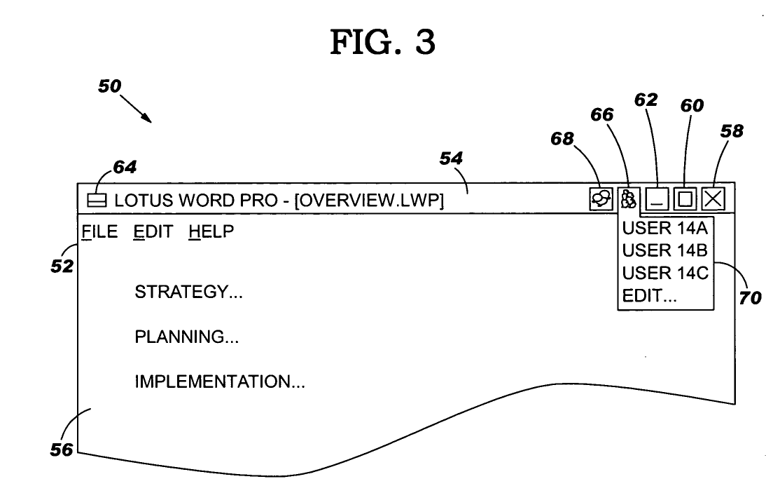

In any event, permissions icon 66 and awareness icon 68 can enable a user 14A-C (FIG. 1) to manage the set of collaboration users. To this extent, permissions icon 66 can enable a user 14A-C to determine the set of collaboration users for a particular shared object 44 (FIG. 1). For example, FIG. 3 shows an illustrative user interface 50 after a user 14A-C has selected permissions icon 66. As shown, a drop down window 70 can be displayed in a portion of user interface 50, which displays a set of users 14A-C who currently have permission to collaborate on shared object 44. It is understood that additional information could be displayed by selecting permissions icon 66. For example, when the set of collaboration users includes users 14A-C with varying access permissions as discussed above, drop down window 70 could indicate the access permissions for users 14A-C.

Further, one or more collaboration management functions (e.g., “Edit”) available to user 14A-C (FIG. 1) can be included in drop down window 70 to allow for selection by user 14A-C. When user 14A-C selects a function, an additional window can appear that allows user 14A-C to implement the desired function in a known manner. For example, user 14A-C could select “Edit” in order to add a user, remove a user, modify a user's access permissions, or the like for shared object 44 (FIG. 1). It is understood that access to one or more collaboration management functions can be limited based on a particular user 14A-C (e.g., a permission level) as is known in the art.

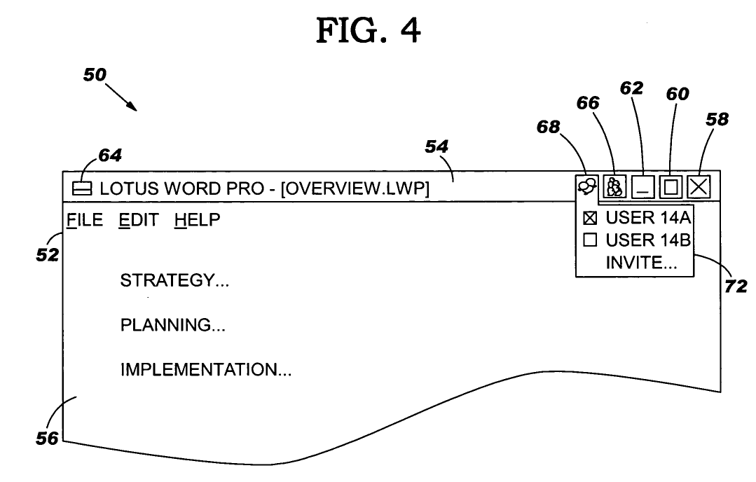

Awareness icon 68 can enable a user 14A-C (FIG. 1) to determine the other users 14A-C that are currently collaborating on shared object 44 (FIG. 1). For example, FIG. 4 shows an illustrative user interface 50 after a user 14A-C has selected awareness icon 68. In this case, a drop down window 72 is displayed in a portion of user interface 50 that displays one or more users 14A-C in the set of collaboration users, and indicates a status for the displayed users 14A-C. In one embodiment, drop down window 72 displays only those users 14A-C that are within the set of collaboration users and have a status of currently using system 10 (FIG. 1), e.g., users 14A-B. Further, drop down window 72 can display a collaboration status for those users 14A-C that are currently using system 10. For example, drop down window 72 is shown including a check box next to each user 14A-B that is checked if user 14A-B is collaborating on shared object 44 (FIG. 1), and not checked if user 14A-B is not collaborating on shared object 44. As with drop down window 70 (FIG. 3), drop down window 72 can also include access to one or more collaboration management functions available to user 14A-C. For example, drop down window 72 is shown including an “Invite” function, which can enable a user (e.g., user 14A) to invite another user (e.g., user 14B) that is using system 10 but not currently collaborating on shared object 44, to join in collaborating on shared object 44.

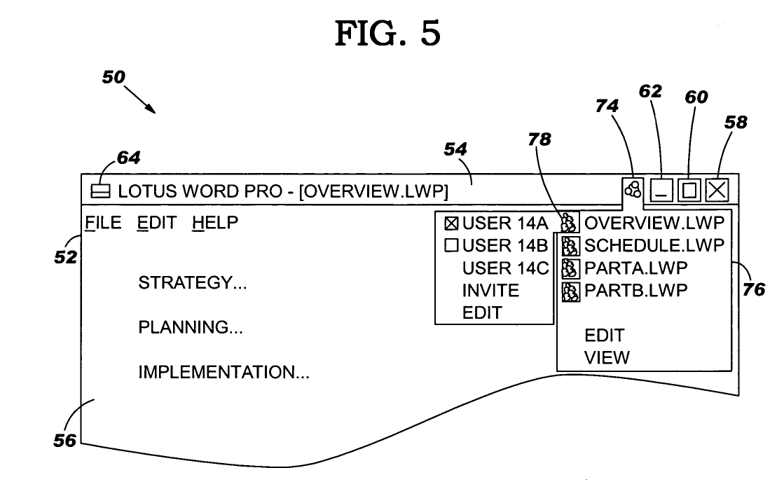

As previously discussed, sharing management system 38 (FIG. 1) can further include an object system 42 (FIG. 1) for managing a set of shared objects 44 (FIG. 1). To this extent, title bar 54 can provide access to one or more collaboration management functions for managing the set of shared objects 44. Further, access to various functions and/or collaboration data 46 (FIG. 1) can be provided through a single collaboration interface. For example, FIG. 5 shows an illustrative user interface 50 in which title bar 54 is shown including a collaboration icon 74. Collaboration icon 74 can provide access to collaboration management functions performed by both object system 42 and user system 40 (FIG. 1).

In particular, a user 14A-C (FIG. 1) can select collaboration icon 74, and be presented with a listing of a set of shared objects 44 (FIG. 1) that are related to a shared object displayed in workspace 56, in a drop down window 76. Drop down window 76 can also provide access to one or more collaboration management functions available to user 14A-C for managing the set of shared objects 44. For example, drop down window 76 is shown including an “Edit” function for modifying the set of shared objects 44. To this extent, a user 14A-C could select “Edit” to add and/or remove one or more shared objects 44 from the set of shared objects 44. Further, drop down window 76 is shown including a “View” function that can change the set of shared objects 44 that is displayed in drop down window 76. For example, only those shared objects 44 having one or more of the same values in collaboration data 46 as the current shared object 44 may be displayed (e.g., all shared objects 44 for which user 14A is in the set of collaboration users). Still further, user 14A-C could select one of the related shared objects 44 and a new user interface could be created to open the selected related shared object 44 and its corresponding collaboration data 46 (FIG. 1). Status information can also be displayed for each shared object 44. For example, an appearance of the shared object can be altered if at least one user 14A-C is currently accessing the shared object 44.

Object system 42 (FIG. 1) can also manage collaboration data 46 (FIG. 1) for each shared object 44 (FIG. 1). For example, collaboration data 46 could include data regarding various events regarding shared object 44. An event can comprise, for example, the creation of shared object 44, a modification of shared object 44, a display of shared object 44, etc. For each event, data such as a date/time stamp, the particular user 14A-C (FIG. 1) that performed the action, etc. can be recorded. Subsequently, a user 14A-C could view all events, events since a particular date/time, the most recent event, etc.

Each listing of a shared object 44 (FIG. 1) is also shown including a user icon 78 that can enable user 14A-C (FIG. 1) to manage the set of collaboration users associated with the corresponding shared object 44. In one embodiment, each user 14A-C in the set of collaboration users is displayed with a corresponding status. For example, for the shared object 44 named “Overview.lwp,” user 14A could be currently collaborating, user 14B could be currently available on system 10 (FIG. 1) but not collaborating, and user 14C could belong to the set of collaboration users but be unavailable on system 10.

Returning to FIG. 1, while sharing management system 38 is shown implemented as part of operating system 32, it is understood that sharing management system 38 can be implemented apart from operating system 32. For example, sharing management system 38 could be implemented as a stand-alone application that runs in the background and inserts interface(s) for managing collaboration data 46 onto a user interface 50 (FIG. 2) for a shared object 44.

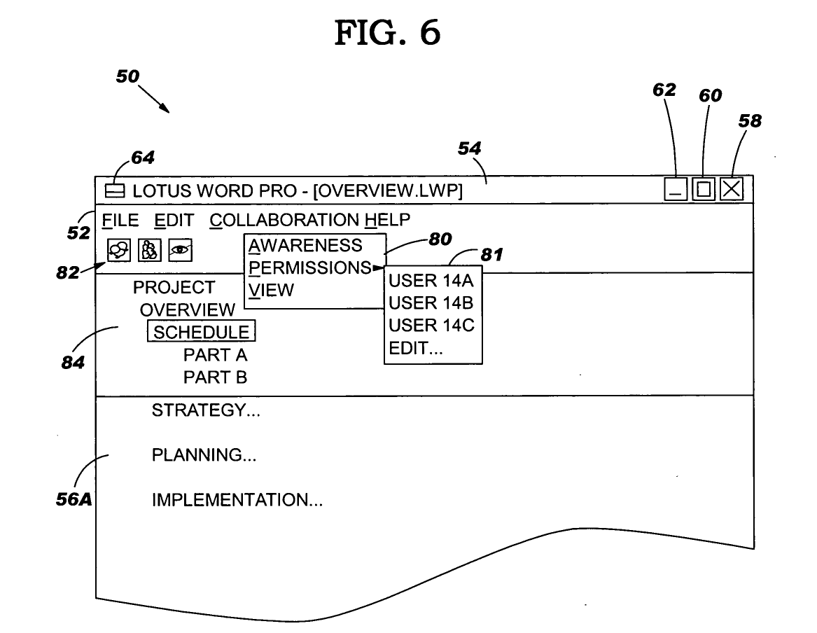

Still further, sharing management system 38 could be implemented as part of application 30. To this extent, FIG. 6 shows an illustrative user interface 50 in which a portion of workspace 56A displays collaboration data 46 (FIG. 1) and includes access to various functions for managing collaboration data 46. In particular, a portion 84 of workspace 56A is shown displaying collaboration data 46. In one embodiment, portion 84 displays a set of shared objects 44 (FIG. 1). In managing the set of shared objects 44, a user 14A-C (FIG. 1) can define a relationship (e.g., “parent-child”) between multiple shared objects 44. To this extent, set of shared objects 44 can be displayed in a tree structure. As a result, the display of shared objects 44 can be limited and/or expanded in any known manner. For example, only those shared objects 44 that have specific collaboration data 46 (e.g., a particular user or group of users is in a corresponding set of collaboration users), a limited/expanded number of levels of the tree, or the like can be displayed.

By defining related shared objects 44 (FIG. 1), default collaboration data 46 (FIG. 1) can be used for a newly created shared object 44. For example, when a new shared object 44 is created and/or added to a set of shared objects 44, some or all of the collaboration data 46 from one or more of the other shared objects 44 in the set of shared objects 44 can be used. For example, a user 14A-C (FIG. 1) could specify a shared object 44 from which to copy collaboration data 46. Alternatively, collaboration data 46 for a shared object 44 can be automatically used. For example, when a child shared object 44 is added to a set of shared objects 44, the collaboration data 46 of its parent shared object 44 can be used by default. It is understood, however, that user 14A-C could override the default collaboration data 46 if desired. Further, when collaboration data 46 for a parent shared object 44 is changed, collaboration data for all its child (children, grandchildren, etc.) shared objects 44 can also be changed.

For example, a user 14A-C (FIG. 1) can select one or more of the displayed shared objects 44 (e.g., “Schedule”), and access collaboration management functions and/or collaboration data 46 (FIG. 1) by, for example, selecting a collaboration menu item or one of a set of collaboration buttons 82. In the former case, a pop-up menu 80 can be displayed, which allows user 14A-C to access one or more collaboration management functions. By selecting the “Permissions” collaboration management function, a second pop-up menu 81 can be created to display collaboration data 46, e.g., the set of users 14A-C having permission to collaborate on the selected shared object 44, and one or more additional collaboration management functions (e.g., “Edit”). Should a user 14A-C modify the set of collaboration users for the “Schedule” shared object 44, the set of collaboration users for its child shared objects 44 (e.g., “Part A” and “Part B”) could be modified as well. Alternatively, all shared objects 44 in the tree and/or only the selected shared object 44 could be modified.

The appearance of the various interfaces shown in FIGS. 2-6 can be temporarily altered when the corresponding collaboration data 46 (FIG. 1) and/or shared object 44 (FIG. 1) has been altered. For example, if a user 14A-C commences or stops collaborating on a shared object 44, awareness icon 68 (FIG. 2) can change color or the like to signal to the other users 14A-C viewing the shared object 44 that a change has occurred. In this manner, the other users 14A-C would be notified that a change in the collaboration status has occurred.

Further, a user 14A-C (FIG. 1) can notify other users 14A-C in the set of collaboration users that a change has been made to a shared object 44 (FIG. 1) and/or its collaboration data 46 (FIG. 1). For example, other users 14A-C currently collaborating on the shared object could be directed to the portion of the shared object 44 that was changed, users 14A-C currently available but not collaborating could be notified by an audio and/or text message, and users 14A-C not currently available could be notified by e-mail or the like. In any event, the other collaboration users would be informed of the change so that they may review the updated data.

It is understood that numerous variations and/or combinations of the illustrative user interfaces depicted in FIGS. 2-6 are possible. For example, icons, images, initials, or the like can be used to identify the various buttons, users 14A-C (FIG. 1), collaboration management functions, and/or shared objects 44 (FIG. 1). Further, collaboration data 46 (FIG. 1) could be displayed within title bar 54 (FIG. 3). For example, an icon for each user in the set of collaboration users could be displayed in title bar 54 along with permission icon 66 (FIG. 3), rather than in drop down window 70 (FIG. 3). Still further, additional status data for users 14A-C can be displayed. For example, each user 14A-C could have a particular color, font, symbol, or the like that is used to display data entered by user 14A-C in shared object 44. As a result, each user 14A-C can be displayed using and/or along with the particular color, font, etc. Additionally, a status indicator can be used to identify a user 14A-C invited to join in the collaboration, users 14A-C that do not have permission to collaborate but are currently using system 10 (FIG. 1), etc.

While the invention is shown and discussed with reference to user interfaces similar to those generated using Microsoft's Windows® operating system 32 (FIG. 1), it is understood that any type of user interface and/or operating system 32 can be used. Further, while the various interfaces have been shown as including pop-up windows, menus, and the like, it is understood that any solution can be used. For example, a portion of the user interface could be reserved for displaying collaboration data 46 and/or providing access to the various functions for managing collaboration data 46. Still further, the various interfaces for collaboration management functions can be disabled and/or not displayed when an object not being shared is displayed or when a user 14A-C doe not have permission to access the function(s).

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer (e.g., a finite state machine), containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of managing collaboration data, the method comprising:
generating a user interface for a shared object using an application;
displaying the shared object in a first portion of the user interface; and
managing collaboration data for the shared object in a second portion of the user interface.

2. The method of claim 1, wherein the managing step includes managing a set of collaboration users.

3. The method of claim 2, wherein the managing a set of collaboration users includes indicating a status for each collaboration user in the set of collaboration users.

4. The method of claim 2, wherein the managing a set of collaboration users includes managing user permissions for the set of collaboration users on the shared object.

5. The method of claim 1, wherein the managing step includes managing a set of shared objects.

6. The method of claim 5, wherein the managing a set of shared objects includes automatically changing collaboration data for a shared object based on a change in collaboration data for a related shared object.

7. The method of claim 5, wherein the managing a set of shared objects includes displaying a set of objects that are related to the displayed shared object.

8. The method of claim 5, wherein the managing a set of shared objects includes opening one of the set of objects that are related to the displayed shared object.

9. The method of claim 1, further comprising modifying the shared object using the user interface.

10. The method of claim 1, wherein the user interface comprises a window, and wherein the second portion includes a title bar for the window.

11. A user interface for managing collaboration data, the user interface comprising:
a first portion of a user interface generated by an application for displaying a shared object; and
a second portion of the user interface for managing collaboration data for the shared object.

12. The user interface of claim 11, wherein the second portion includes at least one icon for accessing a collaboration management function.

13. The user interface of claim 11, wherein the second portion includes a permissions icon for displaying a set of collaboration users for the shared object.

14. The user interface of claim 11, wherein the second portion includes an awareness icon for displaying a set of collaboration users currently accessing the shared object.

15. The user interface of claim 11, further comprising a third portion of the user interface for displaying collaboration data.

16. The user interface of claim 15, wherein the third portion displays a set of shared objects that includes the shared object.

17. A system for managing collaboration data, the system comprising:
an application for providing a user interface and displaying a shared object in a first portion of the user interface; and
a sharing management system for managing collaboration data in a second portion of the user interface.

18. The system of claim 17, further comprising a modification system for modifying the shared object.

19. The system of claim 17, further comprising an operating system.

20. The system of claim 19, wherein the sharing management system is included in the operating system.

21. The system of claim 17, wherein a user interacts with the user interface at a personal workspace.

22. A program product stored on a recordable medium for managing collaboration data, which when executed comprises:
program code for providing a user interface for an application;
program code for displaying a shared object in a first portion of the user interface; and
program code for managing collaboration data for the shared object in a second portion of the user interface.

23. The program product of claim 22, wherein the program code for managing includes program code for managing a set of collaboration users.

24. The program product of claim 22, wherein the program code for managing includes program code for managing a set of shared objects.

25. The program product of claim 22, further comprising program code for modifying the shared object.

26. The program product of claim 22, further comprising program code for automatically changing collaboration data for a related shared object based on a change in collaboration data for the shared object.
